(19) United States
(12) Patent Application Publication
(10) Pub. No.: US 2021/0319203 A1
(43) Pub. Date: Oct. 14, 2021

(54) SYSTEM AND METHODS FOR USING AERIAL DRONES

(71) Applicant: Terry Boufis, Demotte, IN (US)

(72) Inventor: Terry Boufis, Demotte, IN (US)

(21) Appl. No.: 17/225,277

(22) Filed: Apr. 8, 2021

Related U.S. Application Data
(60) Provisional application No. 63/006,783, filed on Apr. 8, 2020.

(51) Int. Cl. G06K 9/00; G08G 5/00; B64C 39/02

(52) U.S. Cl. CPC G06K 9/0063; G08G 5/0013; B64C 39/024; B64C 2201/141; B64C 2201/08; B64C 2201/208; B64C 2201/12

(57) ABSTRACT

Systems and methods include storing an aerial drone in a housing of a unit mounted on a passenger vehicle, launching the aerial drone from the unit, interfacing with a control system to control the aerial drone during flight thereof, obtaining real-time data with a visual recording system and a global positioning system receiver on the aerial drone during flight thereof, and transmitting and storing the data to a remote computer including coordinates of the remote drone and visual data recorded with the visual recording system. Optionally, the data received by the remote computer may be transmitted to individuals and/or organizations such as first responders.

### CROSS REFERENCE TO RELATED APPLICATIONS

This application claims the benefit of U.S. Provisional Application No. 63/006,783, filed Apr. 8, 2020, the contents of which are incorporated herein by reference.

### BACKGROUND OF THE INVENTION

The present invention generally relates to aerial drones (also referred to as unmanned aerial vehicles, or UAVs). The invention particularly relates to systems and methods that utilize aerial drones for organized communication within or between organizations, such as first responders.

Time is often a significant factor when first responders (including but not limited to emergency personnel) respond to an emergency event. A matter of moments may mean the difference between succeeding or failing to save lives and/or property. Unfortunately, first responders commonly arrive at crime scenes, fires, vehicular collisions, and other emergency events with little to no knowledge of the current situation, landscape, etc. This may require time spent accessing the situation upon arrival prior to performing their emergency service duties. In addition, entering an emergency event with limited information may create additional risk for the first responders themselves. Therefore, it can be appreciated that there is an ongoing desire for systems and methods that improve first responders' knowledge of an emergency event prior to arrival and/or reduce the time necessary to access the situation upon arrival.

### BRIEF DESCRIPTION OF THE INVENTION

The present invention provides systems and methods that use aerial drones to improve access to information and communication between various parties.

According to one aspect of the invention, a system is provided that includes an aerial drone comprising a visual recording system, a global positioning system receiver, and a wireless communication system. The system further includes a passenger vehicle that has a unit mounted thereon configured to store the aerial drone in a housing and launch the aerial drone therefrom, a control system for controlling the aerial drone during flight thereof, and the capability to transmit and store real-time data recorded by the aerial drone during flight thereof to a remote computer including coordinates of the remote drone and visual data recorded with the visual recording system.

According to another aspect of the invention, a method is provided that includes storing an aerial drone in a housing of a unit mounted on a passenger vehicle, launching the aerial drone from the unit, interfacing with a control system to control the aerial drone during flight thereof, obtaining real-time data with a visual recording system and a global positioning system receiver on the aerial drone during flight thereof, and transmitting and storing the data to a remote computer including coordinates of the remote drone and visual data recorded with the visual recording system.

Technical effects of the system and method described above preferably include the ability to improve a first responder's knowledge of an emergency event prior to arrival and/or reduce the time necessary to access the situation upon arrival by flying the aerial drone over an area and transmitting data relating to the area to the first responders.

Other aspects and advantages of this invention will be appreciated from the following detailed description.

### BRIEF DESCRIPTION OF THE DRAWINGS

FIG. 1 schematically represents a communication system that utilizes an aerial drone in accordance with certain nonlimiting aspects of the invention.

FIG. 2 schematically represents a vehicle-mounted housing unit and components thereof in accordance with certain nonlimiting aspects of the invention.

FIG. 3 schematically represents an aerial drone being prepared for deployment by an articulating, vehicle-mounted housing unit in accordance with certain nonlimiting aspects of the invention.

FIG. 4 schematically represents a nonlimiting method of operating the system of FIG. 1 in response to the vehicle being involved in a collision in accordance with certain nonlimiting aspects of the invention.

FIG. 5 schematically represents a first responders wearing an apparatus in accordance with certain nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of the embodiments depicted in the drawings. The following detailed description also identifies certain but not all alternatives of the depicted embodiments. Therefore, the appended claims, and not the detailed description, describe what is believed to be one or more aspects of the invention.

Disclosed herein are systems that utilize a vehicle-mounted aerial drone that may be launched into the air and operated to obtain data about an environment and/or a situation and relay such data to various interested parties. The system may be particularly useful for obtaining data relating to emergency events and relaying such data to first responders prior to and/or upon arrival at the emergency event. As used herein, first responders include but are not limited to emergency personnel such as medical personnel, emergency service personnel, police personnel, fire department personnel, etc. Other interested parties may include but are not limited to government or military personnel and individuals or organizations that operate in extreme and/or hard to reach environments. It is foreseeable that the systems and the aerial drones can be used to assist in activities such as search and rescue, reconnaissance, and surveillance.

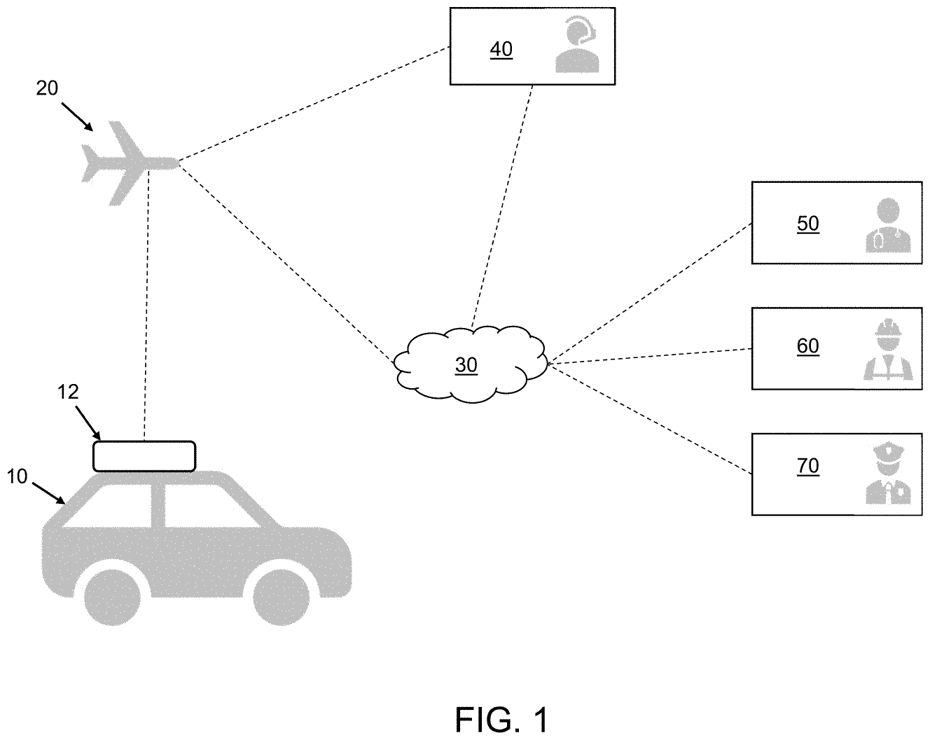

FIG. 1 schematically represents a nonlimiting system that includes a passenger vehicle 10 having a unit 12 mounted thereon that is configured to store and launch an aerial drone 20. While in operation, the aerial drone 20 is configured to fly around a designated area, such as an area surrounding the vehicle 10, and obtain surveillance data (e.g., video, audio, environmental measurements, etc.). The aerial drone 20 is in communication with a remote operator 40 capable of piloting the aerial drone 20 without being physically present in the vicinity of the aerial drone 20, the vehicle 10, or the emergency event.

Such an embodiment may reduce the amount of training needed by the passengers of the vehicle 10 to use the aerial drone 20 and allow them to focus their efforts on other activities, such as providing emergency response services. In certain embodiments, the aerial drone 20 may be configured or capable of semi-autonomous or fully autonomous operation, for example, in which it follows a predetermined flight plan, determines a flight plan in response to readings of the sensors on the aerial drone 20 during operation, receives a flight plan from an operator, or a combination thereof.

Data recorded by the aerial drone 20 is preferably accessible to various individuals and/or organizations in real-time. For example, FIG. 1 schematically represents the aerial drone 20 as being in communication with a remote wireless network 30 which is accessible by other parties, such as but not limited to first responders including medical personnel 50, emergency service personnel 60, and police personnel 70. By providing personnel of these organizations with data obtained by the aerial drone 20, emergency response times may be reduced and emergency service providers may be more prepared upon arrival at emergency events.

In addition, the system may be configured to allow a single individual or organization to coordinate efforts across multiple organizations. The individual or organization may have the capability of providing permission to other parties for access of the data and may determine which portions of the data may be accessible by other parties. Preferably, the system is capable of providing real-time, multi-feed video sharing such that multiple parties may receive and view the data simultaneously. The data may be viewed on various devices such as but not limited to computers, computer tablets, and mobile phones. In certain embodiments, the system may include a downloadable software application (app) that allows parties to view the data (e.g., real-time video, audio, environmental measurements, etc.) and/or communicate with one another simultaneously and in real-time. Preferably, data transmitted by the aerial drone 20 is recorded and stored for future reference on a remote server, for example, part of or wirelessly connected to the remote wireless network 30.

As a nonlimiting example, police officers responding to a car crash can deploy the aerial drone 20 allowing an offsite operator to pilot the aerial drone 20 and obtain data relating to the crash, injuries, traffic, the surrounding environment, etc. The operator may then relay pertinent information to the on-site officers, including but not limited to audible or visual instructions, images, and/or video. In addition, the operator, the on-site officers, or other individuals having access to the real-time information obtained by the aerial drone 20 may coordinate activities by requesting responses by additional parties such as additional police officers, emergency response technicians (EMTs), firefighters, and/or tow truck drivers as necessary. The coordinating individual may further keep these parties updated with real-time information and/or instructions and may prepare other parties such as notifying hospital staff of incoming injured individuals.

Other nonlimiting examples include the ability for remote, specialized individuals (e.g., surgeons and doctors) to provide instructions to on-site individuals (e.g., EMTs and paramedics), the ability to survey continuously or on-demand conditions in an area (e.g., a government transportation department monitoring highway systems), and the ability to organize the actions of a team remotely (e.g., SWAT commander observing multiple SWAT teams and/or members during an operation).

Not only can the system allow for a more organized and efficient response to emergency events, it can provide information that may conventionally be difficult to obtain. For example, the aerial drone 20 may allow firefighters to look through windows of a burning high-rise building and thereby assist in providing a safer and more efficient response to the fire. For military, coast guard, or park services applications, the aerial drone 20 can be equipped with features specific to supporting soldiers/personnel in the field and could assist in reconnaissance, combat/ambush situations, and search and rescue. The system may allow soldiers/personnel to perform reconnaissance in areas that they might not otherwise be able to reach quickly, without diverting other reconnaissance assets. In the event of an ambush, the aerial drone 20 may be configured to automatically deploy, alerting nearby soldiers or other personnel to the situation. If equipped with a thermal camera, the system could help locate missing persons, enemy soldiers, or hidden persons (e.g., snipers) without putting soldiers/personnel in harm's way.

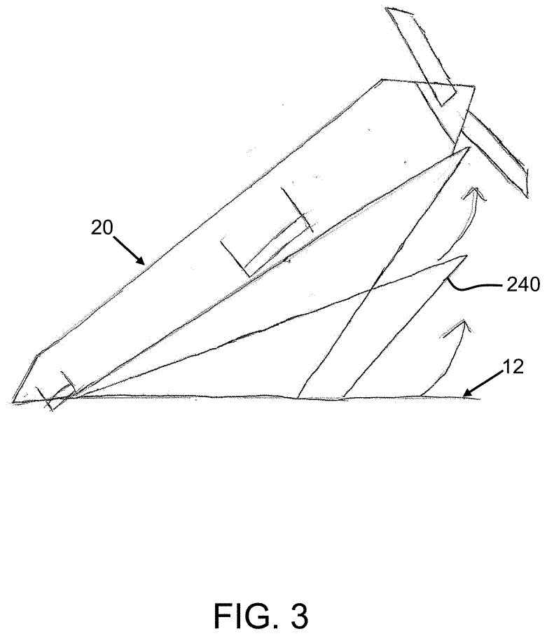

The aerial drone 20 may be any of various types of aerial drones. For example, the aerial drone 20 may be a single- or multi-rotor aircraft such as a helicopter, tricopter, quadcopter, hexacopter, octocopter, etc., or may be a fixed-wing aircraft such as an airplane (as schematically represented in FIGS. 1 and 3). The general operation and construction of functional aerial drones are well known in the art and therefore the discussion herein will focus primarily on data sensing equipment installed on the aerial drone 20 and methods of using the aerial drone 20 and equipment thereon.

Preferably, the aerial drone 20 includes at least a visual recording system that includes a camera configured to record digital images and/or video in at least the visual spectrum, a global positioning system (GPS) receiver capable of obtaining the real-time coordinates of the aerial drone 20, and a wireless communication system configured to relay any obtained data to a remote computer system, for example, part of or wirelessly connected to the remote wireless network 30. The aerial drone 20 may include various other components which may be specific to the intended application. Such components may include cameras capable of recording images and/or video outside of the visual spectrum (e.g., infrared cameras, thermal cameras, etc.), audio receivers (e.g., microphone), audio speakers, environmental sensors (e.g., air quality sensors, toxic chemical sensors, smoke sensors, etc.), and weather-related sensors (e.g., temperature sensors, wind sensors, etc.).

The system includes one or more control systems operable for remotely controlling the aerial drone 20 during its use. Various types of control systems are foreseeable and within the scope of the invention. For example, in certain embodiments, the control system may be mounted within the vehicle 10 and operated by a passenger therein. In another embodiment, the control system may be a portable, handheld electronic device such as a tablet, laptop computer, or smart phone configured to operate the aerial drone 20 remotely via digital display or locally with direct line-of-sight of the aerial drone 20. In yet another embodiment, the control system may be a computer control system located in a remote location. In yet another embodiment, the control system may be a graphic user interface (GUI) operated with a touchscreen display of an electronic device (e.g., mobile phone, tablet computer, laptop computer, etc.). Additionally, the system may include more than one of these or other control systems, and such systems may include a control priority protocol that determines which of the multiple control systems actively control operation of the aerial drone 20 based on predetermined conditions, or may allow for manual switching between the multiple control systems.

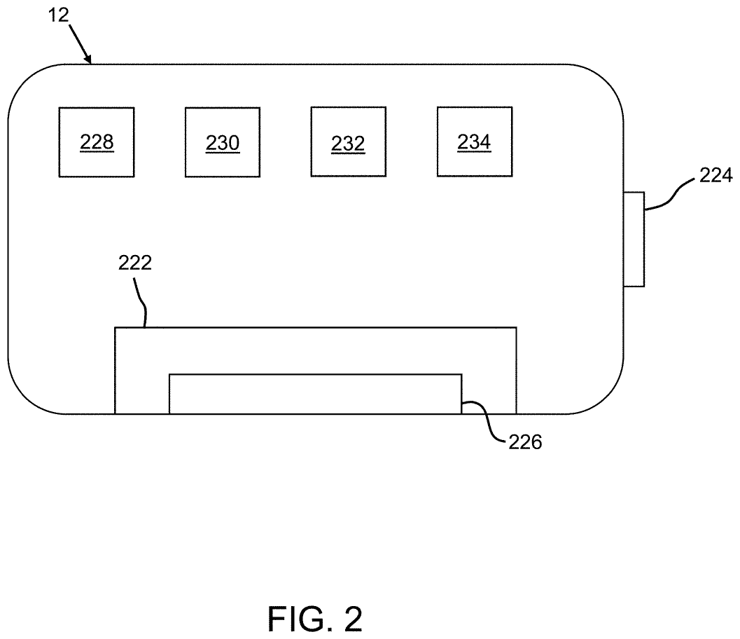

As schematically represented in FIG. 2, the unit 12 may include a protective housing configured to store an aerial drone 20 while not in use. The location of the unit 12 on the vehicle 10 may vary depending on the type of vehicle. In addition, the size and shape of the unit 12 may depend on the size and type of the vehicle 10 on which it is mounted as well as the type of aerial drone 20 which it will store. In certain embodiments, the unit 12 may be configured to protect the aerial drone 20 as well as any other components housed within the unit 12. For example, the unit 12 may be configured to be weather proof, including but not limited to being sealed while closed such that the unit 12 is watertight. The unit 12 may include a frame 222 configured to releasably secure the aerial drone 20 in a fixed position while stored within the unit 12 and during transit of the vehicle 10. In certain embodiments, the unit 12 may include security features such as a locking system 224 configured to deter theft of the aerial drone 20.

The unit 12 may include systems configured to recharge one or more batteries of the aerial drone 20 used for powering operations of the aerial drone 20. For example, the unit 12 may include a charging pad 226 that automatically charges one or more batteries of the drone 20 while the drone 20 is located within the unit 12. In addition or as an alternative, the aerial drone may include one or more ports configured to couple to a power supply to charge the one or more batteries. For example, the aerial drone 20 may include a universal serial bus (USB) port that is capable of being coupled to a battery of the vehicle 10 or another external power supply. Preferably, the system includes the capability to cease charging of the aerial drone 20 once its battery(ies) is fully charged or, if charged by the vehicle 10, when the vehicle 10 is inactive (e.g., engine turned off) to prevent the system from draining the battery of the vehicle 10.

The unit 12 may include systems configured to improve a wireless signal in communication with the aerial drone 20 (i.e., act as a signal booster, signal extender, signal amplifier, signal repeater, etc.). Such systems may be configured to receive an existing wireless signal with a first antenna, boosting the received signal with a signal amplifier, and rebroadcast the boosted signal with a second antenna. For example, the unit 12 may receive one or more signals transmitted from the aerial drone 20, electronic devices in the surrounding area (e.g., a local control system and/or devices receiving data collected by the aerial drone 20), the vehicle 10, and/or a remote server and boost/retransmit such signals to improve connectivity between one or more of these elements of the system. For example, FIG. 2 schematically represents the unit 12 as including a signal booster system 228.

Other devices may be included in the unit 12 to provide additional functionality. For example, the unit 12 may include onboard data storage systems 230 as a backup of the data collected by the aerial drone 20, sensors 232 for collecting data (e.g., camera, microphone, etc.), and a transmitter/receiver system 234 for wireless communication.

The aerial drone 20 may be manually removed from the unit 12 prior to launch. However, in certain embodiments the aerial drone 20 can launch into the air directly from the unit 12. FIG. 3 schematically represents a nonlimiting embodiment wherein the unit 12 includes an articulating ramp 240 configured to raise the aerial drone 20 at least partially out of the housing of the unit 12, and position the aerial drone 20 at an incline such that the aerial drone 20 may launch unimpeded. Launch may be initiated by an operator, such as one of the passengers of the vehicle 10 activating the aerial drone 20 with a mobile controller or controls of the vehicle 10, or by an authorized, off-site (remote) operator.

In addition, the aerial drone 20 may be launched automatically in response to a predetermined event. For example, the aerial drone 20 may be configured to automatically launch in the event of the vehicle 10 being involved in a collision such as a car crash or in any other situations in which the passengers may be incapacitated or otherwise incapable of manually deploying the aerial drone 20. In certain embodiments, the system may be linked with one of the sensors 232 of the unit 12 or sensors of the vehicle 10 such that the system may automatically identify a predetermined event. For example, one of the sensors 232 of the unit 12 may be an accelerometer capable of detecting an impact or other abrupt event, or the system may be linked to an airbag sensor in the vehicle 10 such that the system is capable of detecting an impact sensed by the airbag sensor and/or the deployment of airbags within the vehicle 10. In such events, the system may respond in various manners such as by autonomously alerting interested parties (e.g., first responders) remotely located from the event, transmitting GPS coordinates of the vehicle 10 or the aerial drone 20, and/or launching the aerial drone 20 for surveillance and reporting of the situation.

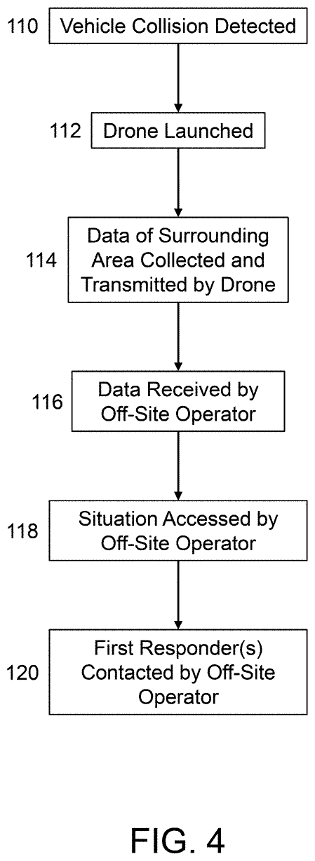

FIG. 4 represents a nonlimiting example of a method of operating the system in response to the vehicle 10 being involved in a collision. In a first step 110, the vehicle 10 is involved in a collision and the aerial drone 20 detects the collision (for example, via a sensor 232 of the unit 12 or an airbag sensor of the vehicle 10) and identifies the collision as a predetermined event requiring a response. In step 112, the aerial drone 20 automatically self-launches from the unit 12 in accordance with onboard instructions associated with the identified predetermined event, that is, a collision. Once launched, the aerial drone 20 may be preprogrammed to fly within a predetermined area surrounding the vehicle 10, and in any event preferably flies in an area surrounding the vehicle 10 and obtains surveillance data (e.g., video, audio, environmental measurements, etc.) relating to, for example, the area itself, the vehicle 10, any passengers therein, and real-time events as they occur in the area. In step 114, the aerial drone 20 transmits the collected data to a remote server. Preferably, the data is transmitted continuously in real-time as the aerial drone 20 surveys the area. In step 116, the data is received on the remote server and accessed by an authorized, off-site operator. In step 118, the operator reviews the data collected by the aerial drone 20, accesses the situation, and determines an appropriate response. In step 120, the operator contacts various first responders to respond to the site of the collision to provide assistance. Optionally, the operator may provide the first responders and/or other parties with access to the data collected by the aerial drone 20 and received by the remote server.

In certain embodiments, the system may include additional equipment usable by individuals, such as passengers of the vehicle 10. For example, the system may include one or more apparatuses that may be worn or carried by individuals that are configured to interact with the aerial drone 20, locally collect and transmit data, improve a wireless signal in communication with the aerial drone 20, and/or provide other functions. Preferably, such apparatuses include a battery pack for powering the devices thereof.

In one embodiment, the system may include a wearable or portable apparatus that is configured to wirelessly communicate with the aerial drone 20 to control the operation of the aerial drone 20 and/or receive transmitted data from the aerial drone 20 for viewing and/or storage. Providing for local data storage may be beneficial for data integrity, for example, in the event that some of the data transmitted by the aerial drone 20 is not received by a remote server.

In another embodiment, the system may include a wearable or portable apparatus that includes one or more sensors configured to locally collect data of the surrounding area. For example, the apparatus may include a visual recording system that includes a camera configured to record digital images and/or video in the visual, infrared, thermal, and/or other spectrums, a GPS receiver capable of obtaining the real-time coordinates of the apparatus, a wireless transmitter configured to relay any obtained data to a remote computer system, audio receivers (e.g., microphone), audio speakers, environmental sensors (e.g., air quality sensors, toxic chemical sensors, smoke sensors, etc.), and weather-related sensors (e.g., temperature sensors, wind sensors, etc.). This apparatus may be beneficial to provide collected data from a different view point than the aerial drone 20, or from a location that is inaccessible by the aerial drone 20. For example, an EMT wearing such an apparatus may be able to provide a video feed to a remote surgeon even when the aerial drone 20 cannot view the immediate area around the EMT, such as within an ambulance. In such embodiments, individuals may be able to selectively view one, two, or more feeds of collected data from one or more of the apparatuses and the aerial drone 20. For example, a remote operator may be able to simultaneously view video feeds from the aerial drone 20 and multiple first responders at the site of the event wearing or carrying such apparatuses.

In yet another embodiment, the system may include a wearable or portable apparatus that is configured to improve a wireless signal in communication with the aerial drone 20 (i.e., act as a signal booster, signal extender, signal amplifier, signal repeater, etc.). Such an apparatus may be configured to receive an existing wireless signal with a first antenna, boosting the received signal with a signal amplifier, and rebroadcast the boosted signal with a second antenna. For example, the apparatus may receive one or more signals transmitted from the aerial drone 20, electronic devices in the surrounding area (e.g., a local control system and/or devices receiving data collected by the aerial drone 20), the unit 12, the vehicle 10, and/or a remote server and boost/retransmit such signals to improve connectivity between one or more of these elements of the system. The apparatus may be particularly beneficial in events such as when an individual using a local control system enters a building that interferes with the control signal, or when the aerial drone 20 is used in a region with poor signal availability, such as a rural area.

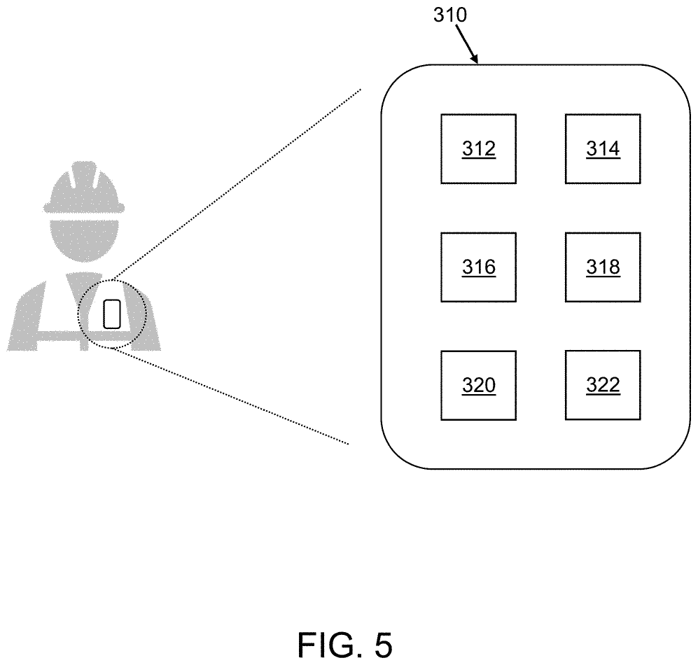

As a nonlimiting example, FIG. 5 schematically represents a first responder as wearing an apparatus 310 that includes a wireless communication system 312 including a receiver and a transmitter, a camera 314, a GPS receiver 316, a two-way audio system 318 that includes a microphone and a speaker, a signal booster 320, and a battery pack 322. The apparatus 310 may be configured to wirelessly communicate and share information with the aerial drone 20, electronic devices in the surrounding area (e.g., other apparatuses 310 and/or devices receiving data collected by the aerial drone 20), the unit 12, the vehicle 10, and/or one or more remote servers.

Although the system is described as including an aerial drone 20 on a vehicle 10, it is foreseeable and within the scope of the invention that the aerial drone 20 may be located or stationed in another location, or the system may include additional aerial drones located or stationed in other locations. For example, additional aerial drones may be stationed on elevated structures such as buildings, towers, and highway sign frames. In such embodiments, the unit 12 may be mounted on such structures.

While the invention has been described in terms of specific or particular embodiments, it should be apparent that alternatives could be adopted by one skilled in the art. For example, the system and its components could differ in appearance and construction from the embodiments described herein and shown in the drawings, and functions of certain components of the system and/or aerial drone 20 could be performed by components of different construction but capable of a similar (though not necessarily equivalent) function. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the phraseology and terminology employed above are for the purpose of describing the disclosed embodiments, and do not necessarily serve as limitations to the scope of the invention. Therefore, the scope of the invention is to be limited only by the claims.

1. A system comprising:
an aerial drone comprising a visual recording system, a global positioning system receiver, and a wireless communication system;
a passenger vehicle that includes a unit mounted thereon configured to store the aerial drone in a housing thereof and launch the aerial drone therefrom;
a control system for controlling the aerial drone during flight thereof; and
means for transmitting and storing real-time data recorded by the aerial drone during flight thereof to a remote computer including coordinates of the aerial drone and visual data recorded with the visual recording system.

2. The system of claim 1, wherein the control system includes a remote control system within the vehicle.

3. The system of claim 1, wherein the control system includes a remote control system in a remote location without direct physical line-of-sight of the aerial drone.

4. The system of claim 1, wherein the control system includes an onboard control system configured for autonomous flight.

5. The system of claim 1, wherein the data stored on the remote computer is accessible remotely by first responder.

6. The system of claim 1, wherein the unit includes an articulating ramp configured to raise the aerial drone at least partially out of the housing in preparation for launch of the aerial drone.

7. The system of claim 1, wherein the aerial drone is configured to automatically launch and transmit the data in the event of an emergency.

8. The system of claim 7, wherein the emergency involves the vehicle being involved in a collision.

9. The system of claim 1, wherein the aerial drone is configured to automatically launch and transmit data in response to a signal indicating that one or more airbags in the vehicle have deployed.

10. The system of claim 1, wherein the unit includes a locking system configured to deter theft of the aerial drone stored therein.

11. The system of claim 1, wherein the unit is configured to charge a battery on the aerial drone.

12. The system of claim 1, further comprising a wearable device comprising a signal booster configured to improve wireless communication with the aerial drone.

13. A method comprising:
storing an aerial drone in a housing of a unit mounted on a passenger vehicle;
launching the aerial drone from the unit;
interfacing with a control system to control the aerial drone during flight thereof;
obtaining real-time data with a visual recording system and a global positioning system receiver on the aerial drone during flight thereof; and
transmitting and storing the data to a remote computer including coordinates of the remote drone and visual data recorded with the visual recording system.

14. The method of claim 13, wherein the control system is a remote control system in a remote location without direct physical line-of-sight of the aerial drone during the interfacing step.

15. The method of claim 13, wherein the control system is an onboard control system that operates the flight of the aerial drone autonomously.

16. The method of claim 13, further comprising accessing the data stored on the remote computer and transmitting the data to first responders.

17. The method of claim 16, wherein multiple first responders in different locations receive and view the data simultaneously.

18. The method of claim 13, further comprising raising an articulating ramp of the unit to raise the aerial drone at least partially out of the housing in preparation for launch of the aerial drone.

19. The method of claim 13, further comprising automatically launching the aerial drone and transmitting the data in the event that the vehicle is involved in a collision.

20. The method of claim 13, further comprising automatically launching the aerial drone and transmitting the data in response to a signal indicating that one or more airbags in the vehicle have deployed.
